(19) United States
(12) Patent Application Publication
(10) Pub. No.: US 2025/0070124 A1
(43) Pub. Date: Feb. 27, 2025

(54) TOOLS AND METHODS FOR PRODUCING ELECTRODES FOR LITHIUM-ION BATTERIES

(71) Applicant: FORD GLOBAL TECHNOLOGIES, LLC, Dearborn, MI (US)

(72) Inventor: Wilhelm Siebert, Farmington Hills, MI (US)

(21) Appl. No.: 18/453,358

(22) Filed: Aug. 22, 2023

(51) Int. Cl. H01M 4/139

(52) U.S. Cl. CPC H01M 4/139; H01M 2220/20

(57) ABSTRACT

A method of manufacturing an electrode includes supplying a material stack into a chamber of a vertical press. The material stack includes a current collector sheet and active material disposed thereon. The method further includes closing the vertical press to compress the material stack forming an electrode blank; and, while stilled compressed, cutting the electrode blank to length while simultaneously cutting a current collector tab to form a finished electrode.

### TECHNICAL FIELD

This disclosure relates to the production of Lithium-ion batteries and more particularly to manufacturing electrodes.

### BACKGROUND

A vehicle may include an electric powertrain. The powertrain may include one or more electric machines capable of acting as motors to propel the vehicle and as generators to regeneratively brake the vehicle. The one or more electric machines may be powered by a traction battery. The traction battery may include a plurality of battery cells. The battery cells may have a lithium-ion chemistry.

### SUMMARY

According to one embodiment, a method of manufacturing an electrode includes supplying a material stack into a chamber of a vertical press. The material stack includes a current collector sheet and active material disposed thereon. The method further includes closing the vertical press to compress the material stack forming an electrode blank; and, while stilled compressed, cutting the electrode blank to length while simultaneously cutting a current collector tab to form a finished electrode.

According to another embodiment, a method of manufacturing an electrode includes opening a tool having side-by-side presses such that upper dies of the presses are spaced from lower dies of the presses; supplying a material stack including a current collector sheet and active material disposed thereon into the presses; simultaneously closing the presses to compress the material stack between the dies of each press to form a pair of coated films; and, while stilled compressed, cutting the coated films to form two electrodes.

According to yet another embodiment, a tool for forming a battery electrode includes a press having a lower die and an upper die closable to compress a current collector between active material layers to form an electrode blank. A cutting tool is attached to one of the lower and upper dies. The cutting tool including a continuous cutting edge that completely circumscribes the one of the lower and upper dies, wherein the cutting edge includes a first portion configured to cut a tab in the current collector and a second portion configured to cut a first side of the electrode blank

### BRIEF DESCRIPTION OF THE DRAWINGS

FIG. 1 is a perspective view of an example battery cell.

FIG. 2 is a diagrammatical perspective view of an example electrode for use in a battery cell.

FIG. 3 is a diagrammatical side view of a tool for producing an electrode from a dry active material.

FIG. 4 is a top view of a material stack.

FIG. 5 is a diagrammatical bottom view of an upper die and cutting unit of the tool of FIG. 3.

FIG. 6 is a diagrammatical side view of another tool for producing an electrode.

FIG. 7 is a diagrammatical side view of a yet another tool for producing multiple electrodes in a single cycle.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

An electrified vehicle may include one or more electric machines mechanically connected to driven wheels through a driveline. The electric machines may be capable of operating as a motor or a generator. In the case of a hybrid, an engine is connected to one or more electric machines through a transmission. The electric machines can provide propulsion and braking capability. The electric machines also act as generators and can provide fuel economy benefits by recovering energy through regenerative braking.

A traction battery or battery pack stores energy that can be used by the electric machines. The traction battery typically provides a high-voltage direct current (DC) output from one or more battery cell arrays, sometimes referred to as battery cell stacks, within the traction battery. The battery cell arrays include one or more battery cells.

The battery cells, such as a prismatic, pouch, cylindrical, or any other type of cell, convert stored chemical energy to electrical energy. The cells may include a housing, a positive electrode (cathode), and a negative electrode (anode). An electrolyte allows ions to move between the anode and cathode during discharge, and then return during recharge. Terminals may allow current to flow out of the cell for use by the vehicle.

Different battery pack configurations may be available to address individual vehicle variables including packaging constraints and power requirements. The battery cells may be thermally controlled with a thermal management system. Examples of thermal management systems include air cooling systems, liquid cooling systems, and a combination of air and liquid systems.

The traction battery may be electrically connected to one or more power electronics modules through one or more contactors (not shown). The one or more contactors isolate the traction battery from other components when opened and connect the traction battery to other components when closed. In addition to providing energy for propulsion, the traction battery may provide energy for other vehicle electrical systems.

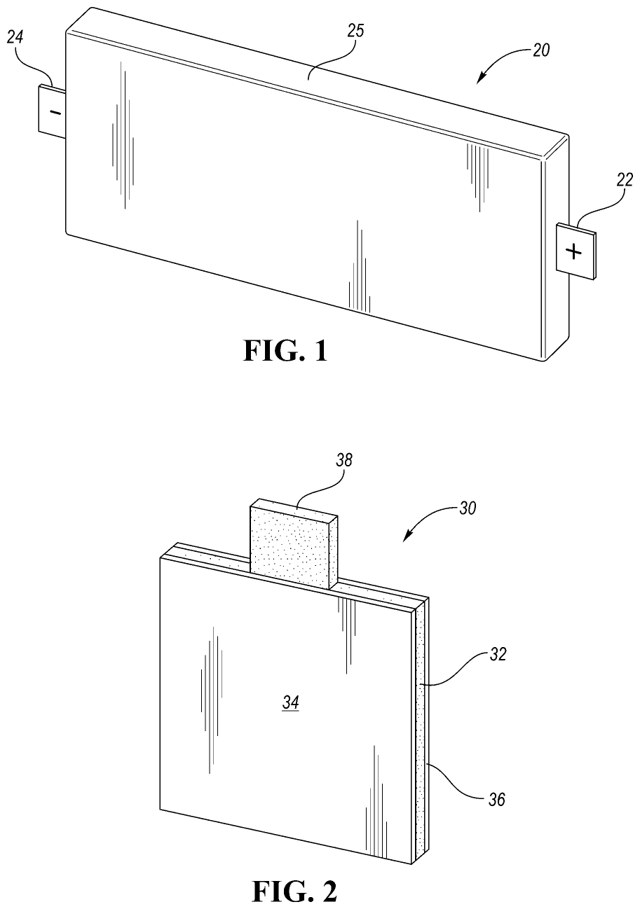

The traction battery assembly includes one or more battery arrays each having a plurality of battery cells arranged in stack. An example battery cell 20 is shown in FIG. 1. The cells may be pouch cell, prismatic cells, cylindrical cells, or the like. Positive and negative terminals 22, 24 extend from an outer body 25 of the cell 20. Each cell 20 may have two terminals, e.g., with the positive and negative terminals extending from different sides (as shown) or on a same side. Generally, within each cell is a cathode, an anode, a separator, and an electrolyte. The positive terminal 22 is electrically connected to the cathode, and the negative terminal 24 is electrically connected to anode. The anode and the cathode may be referred to as electrodes.

Referring to FIG. 2, an electrode 30 may be used as the anode or the cathode. The electrode may be used in a lithium-ion battery or other suitable chemistry. In one embodiment, the electrode 30 is associated with an anode of a lithium-ion battery. The electrode 30 generally includes three layers: a middle current conductor layer 32 and first and second outer layers 34, 36 bonded to the current collector 32. The current collector 32 is formed of metal such as copper, aluminum, or other suitable electrically conductive material and includes a tab 38 providing an electrical connector. The outer layers 34, 36 may be referred to as active material coating. The outer layers 34, 36 are produced using either a “dry” process or a “wet” process.

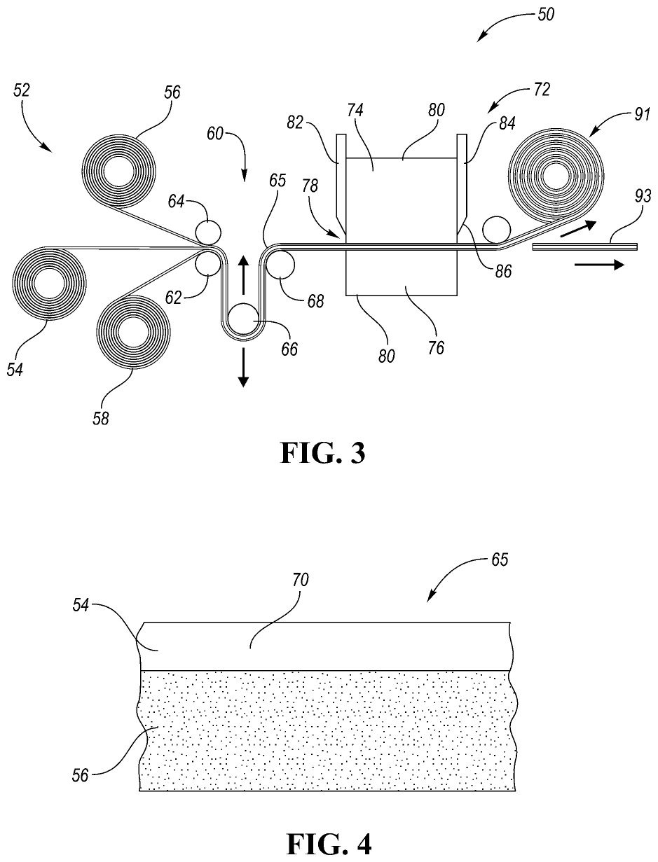

FIG. 3 illustrates an example tool 50 configured to produce an electrode using a press-and-cutting process. The illustrated tool 50 is for use with a dry active material. The tool 50 includes an input area 52 supporting a roll of current collector 54, a roll of upper coating material 56 (active material), and a roll of lower coating material 58 (active material). The upper coating 56, the current collector 54, and the lower coating 58 are fed into a dancer system 60 that includes a pair of entry rollers 62, 64, a movable roller 66, and an exit roller 68. The roller 62, 64, 66 are stationary, whereas the roller 68 is movable up and down.

The upper coating 56, the current collector 54, and the lower coating 58 are fed in between the rollers 62 and 64 to create a material stack 65, which will be processed into a finished electrode. The width of the current collector role 54 may be wider than the coating rolls 56, 58 such that the material stack has exposed current collector 70 along the edge(s) as shown in FIG. 4. The exposed current collector will later be cut to form tabs of the electrodes.

The tool 50 includes a press 72 having an upper die 74 and a lower die 76. The upper and lower dies 74, 76 are movable relative to each other between an open position and a closed position. For example, the lower die 76 may be stationary and the upper die 74 may move up and down. The dies 74, 76 cooperate to define a press chamber 78.

The material stack 65 is received within the open press chamber 78 with the upper die 74 spaced from the lower die 76. The roller 66 is moved up to reduce the tension when the material stack is being fed into the press 72 and is moved down (the position shown) when a sufficient amount of material stack has been fed into the press chamber 78 to increase the tension.

The press 72 is used to bond the upper coating 56 and the lower coating 58 to the current collector 54. This is in contrast to the traditional method of calendaring. The upper die 74 is lowered towards the lower die 76 to compress the material stack thus binding the active material 56, 58 to the current collector 54. At this point, the material stack may be referred to as a coated film or electrode blank. The press 72 may be heated (optional). For example, heating channels 80 may be defined within the upper die 74, the lower die 76, or both. The heating channels 80 are configured to circulate a hot fluid, e.g., oil, to heat the dies, which may be metal. Alternatively, electric heating elements may be used. During the pressing, the pressure is controlled to achieve a target electrode density, porosity, and thickness.

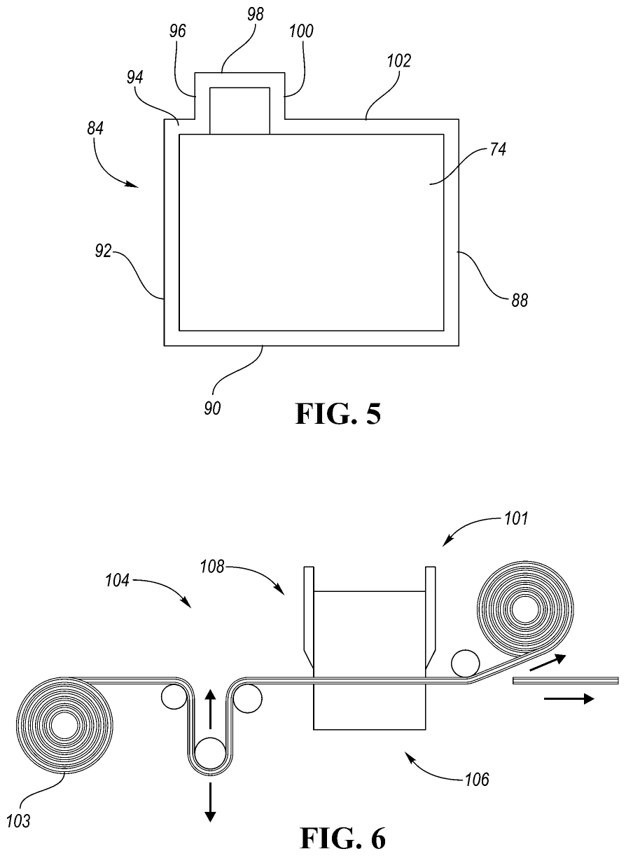

Referring to FIGS. 3 and 5, the tool 50 also includes a cutting unit 82 configured to cut the coated film. The cutting unit 82 is configured to simultaneously cut both the coated film to the desired length and cut the tab from the exposed edge 70 of the current collector 54. The cutting unit 82 includes a cutting tool 84 supported on the press 72. For example, the cutting tool 84 may be movably attached to the upper die 74 such that the cutting tool 84 can move up and down. Alternatively, the cutting tool 84 may be mounted to the lower die 76 or other support structure. The cutting tool 84 includes a cutting edge 86. The cutting edge 86 may be continuous and form a closed polygon. The cutting tool 84 and cutting edge 86 may be sized to circumscribe the upper die 74 or the lower die 76 or both. The cutting edge 86 may be formed of a plurality of segments, which may be straight. For example, the cutting edge 86 includes a first segment 88, a second segment 90, a third segment 92, a fourth segment 94, a fifth segment 96, a sixth segment 98, and a seventh segment 100 that are all interconnected to form the continuous cutting edge. The segments 88 and 92 cut the electrode blank to desired length. The segments 90, 94, and 102 cut the electrode blank to the desired width. The segments 96, 98, and 100 are used to cut the tab in the current collector. All of the segments of the cutting edge 86 may be coplanar.

The cutting unit 82 include a lowering mechanism (not shown) that is used to move the cutting tool 84 up and down. The lowering mechanism may be a hydraulic, pneumatic, electronic, manual, or the like. The cutting edge 86 (or other portion of the cutting tool 84) may be heated. The heating may be electric, fluid, or the like.

The tool 50 integrates the various separate processes of the traditional electrode forming method into a single tool creating an efficient and streamlined process for forming an electrode. This new process begins by feeding the upper coating 52, current collector 54, and lower coating 58 into the dancer system 60 creating the material stack. The material stack 65 is fed into the open press 72. Once properly positioned, the upper die 74 is lowered towards the lower die 76 with the cutting tool 84 retracted. The upper and lower die 74, 76 compress the active materials of the upper and lower coatings 56, 58 on to the current collector 54 creating an electrode blank. The press provides the desired pressure, temperature, and hold time to properly bond the active material to the current collector. Next, the electric blanket is cut to form the desired size for the electrode and to cut the current collector tab. This cutting occurs while the dies are still compressed. The electrode blank is cut by lowering the cutting tool 84 through the electrode blank. This single cutting process performs all necessary cutting, and once complete, a finished electrode 93 is produced. The dies are then opened allowing the completed electrode 93 to be separated from the scrap. The scrap may be wound on a scrap roll 91 and the completed electrode 93 may be loaded in a magazine and passed to another area for assembly into a battery cell. Alternatively, the electrode may be directly passed to the next manufacturing process.

The tool 50 may include a suction system (not shown) used to separate the electrode 93 from the scrap 91. For example, once the cut is completed the cutting tool 84 starts retracting towards its home position, while the upper die 74 remains down to hold the cut electrode in place to prevent any lifting of the electrode. Once the cutting tool has passed a certain height of the upper die (a sensor inside upper die may check travel) the upper die lifts off of the electrode. Since the electrode is still located in the surrounding foil, it may be carried by its foil onto a suction conveyor. At this point, the scrap material will be lifted off while the electrode will be held via suction on the conveyor and is transported to a visual inspection system (optional) and, depending on the inspection result, into a scrap bin or the magazine unit for further processing in the equipment downstream. The tool 50 may include multiple presses arranged upstream and downstream of each other allowing multiple electrodes to be produced each cycle.

FIG. 6 illustrates another tool 101 for use with electrodes made from solvent-based slurry or solvent-free dry active material. In the illustrated embodiment, tool 101 is loaded with a solvent-based slurry active material. Here, the material stack is previously formed and coiled by another tool, and the preformed roll 103, e.g., a mother roll or a daughter roll, is supported on a spool of the tool 101. The roll 103 may include an exposed edge of current collector as described above. Similar to the tool 50, the tool 101 includes a dancer system 104 for feeding the material stack 103 to the press 106. The press 106 may be the same or similar to the press 72. The presses 72 and 106 may be slightly different to account for the differences in the wet versus dry active material. For example, the pressure and/or the press times may be varied as needed. A cutting system 108, which may be the same or similar to the cutting unit 82, may be supported on the press. With the exception of the formation of the material stack, the tool 101 may produce an electrode similar to the above-101 discussed process, and for brevity this will not be described again. The tool 101 may include multiple presses arranged upstream stream and down steam of each other allowing multiple electrodes to be produced each cycle.

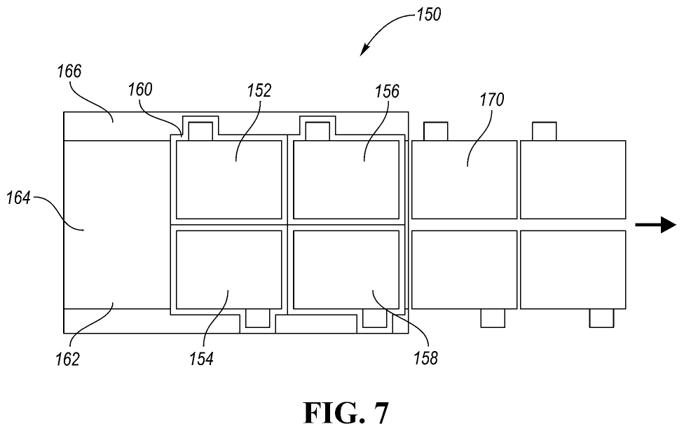

FIG. 7 illustrate another tool 150 that includes multiple presses. The tool 150 may be used with either electrodes made from solvent-based slurry or solvent-free dry active material. If the tool 150 is used for dry, an input area (not shown) similar to input area 52 may be included with the tool 150. In this example, four presses are shown; however, is to be understood that this is just an example and that the tool 150 may include two presses or more than four presses. In the illustrated embodiment, the presses are arranged in side-by-side pairs, which allow a mother roll (a roll having exposed current collector on both sides) to be feed into the tool 150. Similar to the above tools, and unbonded material stack is provided at the input side of the tool 150 and a finished electrode, or in this case electrodes, is output.

The tool 150 includes a first press 152 arranged side-by-side with a second press 154. A second pair of presses 156 and 158 are arranged side-by-side downstream of the first pair of presses. Each press includes an associated upper and lower die and cutting tool 160. This allows four electrodes to be produced during each cycle of the tool 150. The upper and lower dies and cutting tool 160 may be the same or similar to those described above. By arranging the presses side-by-side, a mother roll can be provided into the tool 150 thus skipping the traditional manufacturing step of slitting to produce a daughter roll.

Material stack 162 is fed into the tool 150 such that the material stack is disposed within the chambers of each of the presses. Similar to the above-described process, the upper and lower dies are then closed to bond the active material 164 to the current collector 166 forming four electrode blanks. Next, the electrode blanks cut using the cutting tools 160 as described above. This cutting process produces four electrodes 170 that are transferred to a conveyor or other area for installation into a battery cell. In this example, all four of the dies may be closed at the same time and all four of the cutting tools may be deployed at the same time so that the four electrodes are produced simultaneously.

The above-described tools combine multiple steps of the traditional manufacturing process (performed with dedicated tools, e.g., a calendaring machine, a slitting machine, and a notching machine) into simultaneous steps performed on a single tool. This may increase efficiency by limiting the number of tools needed to produce an electrode.

Utilizing a press to form the electrode blank also overcomes short falls of the calendaring process. For example, calendaring creates shear stresses in the active material. In the process of this disclosure, these shear stresses are diminished because the sheer forces produced during pressing are outside the cutline of the cutting tool.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of manufacturing an electrode comprising:
supplying a material stack into a chamber of a vertical press, wherein the material stack includes a current collector sheet and active material disposed thereon;
closing the vertical press to compress the material stack forming an electrode blank; and
while stilled compressed, cutting the electrode blank to length while simultaneously cutting a current collector tab to form a finished electrode.

2. The method of claim 1 further comprising, opening the vertical press such that the finished electrode is lifted from waste material of the blank.

3. The method of claim 1, wherein the press includes an upper die and a lower die and further comprising, lifting the finished electrode off the lower die via the upper die.

4. The method of claim 1, wherein the active material is a film of active material.

5. The method of claim 1, wherein the cutting of the current collector includes actuating a cutting tool attached to the vertical press.

6. The method of claim 1, wherein the press includes an upper die, a lower die, and a cutting tool slidably coupled to the upper die, wherein the cutting of the current collector includes lowering the cutting tool past a bottom surface of the lower die.

7. The method of claim 6, wherein the cutting tool includes a cutting edge having a closed-polygonal cross section when viewed from a bottom of the cutting tool.

8. A method of manufacturing an electrode comprising:
opening a tool having side-by-side presses such that upper dies of the presses are spaced from lower dies of the presses;
supplying a material stack including a current collector sheet and active material disposed thereon into the presses;
simultaneously closing the presses to compress the material stack between the dies of each press to form a pair of coated films; and
while stilled compressed, cutting the coated films to form two electrodes.

9. The method of claim 8, wherein the cutting includes simultaneously cutting the current collector sheet to form tabs and cutting the material stack to length.

10. The method of claim 8, wherein each of the presses includes an associated cutting tool that performs the cutting.

11. The method of claim 10, wherein each of the cutting tools includes a first cutting edge configured to cut a corresponding one of the tabs and a second cutting edge configured to cut the material stack to length.

12. The method of claim 8, wherein the active material is narrower than the current collector sheet such that the current collector sheet is exposed along side edges of the material stack.

13. The method of claim 8 further comprising, opening the presses, after the cutting, such that the electrodes remain attached to their respective upper or lower dies while waste material remains attached to the other of the upper or lower dies.

14. The method of claim 8, wherein the cutting the coated films includes sliding cutting tools, each associated with one of the presses, through the coated films.

15. The method of claim 14, wherein the cutting tools are slidably attached to the upper dies.

16. The method of claim 8 further comprising heating the upper and lower dies of the presses during at least a portion of the closing of the presses.

17. The method of claim 8 further comprising feeding rolls of current collector and upper and lower coating films through a dancer system of the tool to form the material stack.

18. A tool for forming a battery electrode, the tool comprising:
a press including a lower die and an upper die closable to compress a current collector between active material layers to form an electrode blank; and
a cutting tool attached to one of the lower and upper dies, the cutting tool including a continuous cutting edge that completely circumscribes the one of the lower and upper dies, wherein the cutting edge includes a first portion configured to cut a tab in the current collector and a second portion configured to cut a first side of the electrode blank.

19. The tool of claim 18, wherein the cutting edge further includes a third portion configured to cut a second side of the electrode blank, a fourth portion configured to cut a third side of the electrode blank, and a fifth portion configured to cut a fourth side of the electrode blank.

20. The tool of claim 19, wherein the second, third, fourth, and fifth portions are straight segments arranged to form a rectangle.
